(19) United States
(12) Patent Application Publication
(10) Pub. No.: US 2009/0208712 A1
(43) Pub. Date: Aug. 20, 2009

(54) METHOD TO DECREASE WARPAGE OF MULTI-LAYER SUBSTRATE AND STRUCTURE THEREOF

(75) Inventor: Chih-kuang Yang, Hsin-Chu City (TW)

Correspondence Address: KIRTON AND MCCONKIE, 60 EAST SOUTH TEMPLE,, SUITE 1800, SALT LAKE CITY, UT, 84111, US

(73) Assignee: PRINCO CORP., Hsinchu (TW)

(21) Appl. No.: 12/207,685

(22) Filed: Sep. 10, 2008

(30) Foreign Application Priority Data
Feb. 18, 2008 (TW) 097105644

(51) Int. Cl. B32B 3/10

(52) U.S. Cl. 428/209

(57) ABSTRACT

Disclosed is a method to decrease warpage of a multi-layer substrate, comprises a first metal layer and a second metal layer. First area of the first metal layer is larger than second area of the second metal layer. In the same layer of the second metal layer, a redundant metal layer can be set to make a redundant metal layer area plus the second area considerably equivalent to the first area. Alternatively, a redundant space can be set in the first metal layer to achieve the same result. When the multi-layer substrate comprises a first dielectric layer with an opening and a second dielectric layer, a redundant opening positioned corresponding to the opening can be set in the second dielectric layer. The present invention employs a method of balancing the multi-layer substrate stress, i.e. to homogenize the multi-layer structure composed of different metal layers and dielectric layers to decrease warpage thereof.

### BACKGROUND OF THE INVENTION

1. Field of the Invention

The present invention generally relates to a method to decrease warpage of a multi-layer substrate, and more particularly to a method of balancing a flexible multi-layer substrate stress to decrease warpage or twist of the multi-layer substrate for stresses generated by occupied area differences and occupied location differences of different metal layers and dielectric layers.

2. Description of Prior Art

A multi-layer substrate today may employ coating method to form a plurality of dielectric layers and corresponding metal layers between these dielectric layers are formed by lithography process. The aforesaid dielectric layers and metal layers are alternately stacked-up to realize the aforementioned multi-layer substrate having advantage of thin thickness and simple materials. Moreover, such coating method can be significantly suitable for manufacturing flexible multi-layer substrate.

The wet films were formed by the dielectric layers coating method, therefore, the steps of drying these dielectric layers to be hardened thereof, are needed hereafter. Different metal layers have different areas and different locations because of respective circuit designs. Accordingly, dielectric layers corresponding to different metal layers may have different areas, also. After the metal layers and the dielectric layers are stacked-up and the aforesaid drying and hardening process are proceeded, shrinkage rates of respective dielectric layers may be different (although all dielectric layers' materials are the same, the shrinkage rates can be different due to respective shapes, occupied areas and volumes). Consequently, stresses become unbalanced between some metal layers and some dielectric layers to result in warpage or twist of the multi-layer substrate. Even the dielectric layers that are not formed by the coating method, unbalanced stress can cause warpage or twist of the multi-layer substrate that happens because of different volumes, thicknesses materials, or constructions of different metal layers and dielectric layers.

The aforesaid warpage or twist can seriously influence precision of whole system assembly later on, even unable to assembly the whole system. Furthermore, speaking of design application of a flexible multi-layer substrate, foldable characteristic is the major purpose of developing the flexible multi-layer substrate industry. After the flexible multi-layer substrate is applied into productions, some specific areas, even the entire substrate can be bent frequently. If the stress, warpage or twist problems of the multi-layer substrate are not solved, the lifetime of the production can be shorter and cannot be commercialized.

### SUMMARY OF THE INVENTION

An objective of the present invention is to provide a method to decrease warpage of a multi-layer substrate by balancing a multi-layer substrate stress generated by occupied area differences and occupied location differences of different metal layers and dielectric layers.

For accomplishing aforesaid objective of the present invention, the present invention employs to a multi-layer substrate having a first metal layer and a second metal layer at least and a first area of the first metal layer is larger than a second area of the second metal layer, wherein at least one redundant metal layer is set in the same layer of the second metal layer so that a redundant metal layer area plus the second area is considerably equivalent to the first area. The redundant metal layer and the second metal layer are positioned corresponding to the first metal layer which is subject to a central plane which is parallel with the first metal layer and the second metal layer. Furthermore, the method to decrease warpage according to the present invention can still be functional when a third metal layer is located between the first metal layer and the second metal layer.

Moreover, when a first surface dielectric layer located at a first surface of the multi-layer substrate has at least one opening, the second surface dielectric layer located at a second surface of the multi-layer substrate can be set at least one redundant opening positioned corresponding to the at least one opening. According to the present invention, stresses caused by different occupied areas and locations of different metal layers and dielectric layers can be balanced, i.e. homogenizing occupied areas and locations of different metal layers and dielectric layers to decrease warpage or twist of the multi-layer substrate.

### BRIEF DESCRIPTION OF THE DRAWINGS

FIG. 1 depicts a diagram of a first embodiment to decrease warpage of a multi-layer substrate according to the present invention.

FIG. 2 depicts a diagram of a second embodiment to decrease warpage of a multi-layer substrate according to the present invention.

FIG. 3 depicts a diagram of a third embodiment to decrease warpage of a multi-layer substrate according to the present invention.

FIG. 4 depicts a diagram of a fourth embodiment to decrease warpage of a multi-layer substrate according to the present invention.

FIG. 5 depicts a diagram of a fifth embodiment to decrease warpage of a multi-layer substrate according to the present invention.

### DETAILED DESCRIPTION OF THE INVENTION

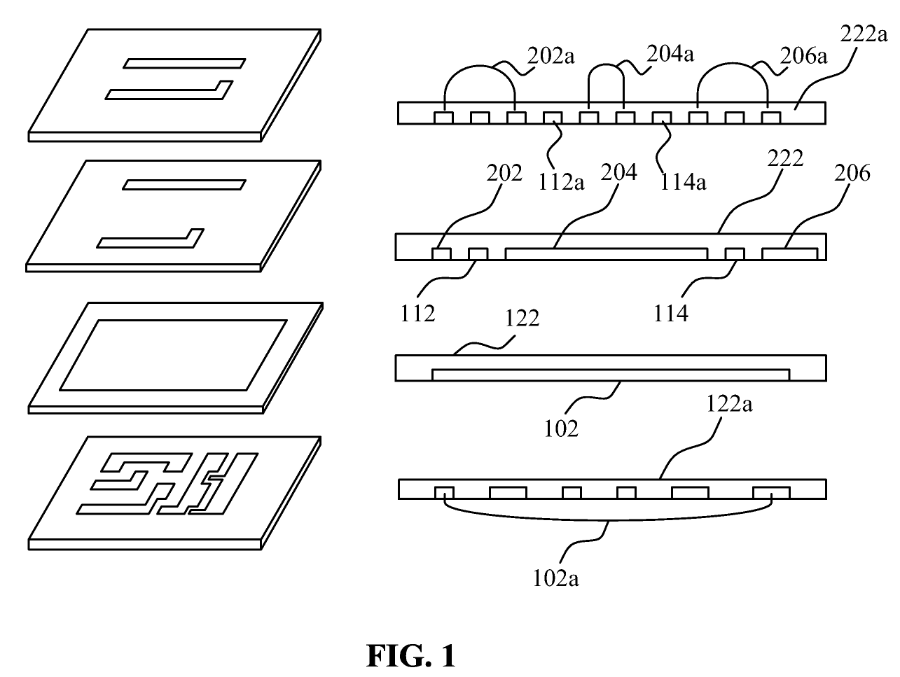

Please refer to FIG. 1, which depicts a diagram of a first embodiment to decrease warpage of a multi-layer substrate according to the present invention. On the left side of FIG. 1, a three dimensional view of a multi-layer substrate is shown and a corresponding profile drawing is shown on the right side. The multi-layer substrate comprises a first metal layer 102, a first dielectric layer 122 corresponding thereto, second metal layers 112, 114 and a second dielectric layer 222 corresponding thereto.

As aforementioned, the first dielectric layer 122 and the second dielectric layer 222 are formed by a coating method. The aforesaid drying and hardening process is proceeded, and shrinkage rates of respective dielectric layers may be different. Stresses become unbalanced between some metal layers and dielectric layers to result in warpage of the multi-layer substrate. Moreover, even the dielectric layers are not formed by the coating method, unbalanced stress between the metal layers and dielectric layers of the multi-layer substrate are making warpage thereof to happen because of different volumes, thicknesses, materials, or constructions of different metal layers and dielectric layers. Therefore, the present invention can be employed to homogenize the multi-layer structure composed of different metal layers and dielectric layers as shown in FIG. 1.

Because an area of the first metal layer 102 occupies most of the multi-layer substrate and is larger than an area of the second metal layers 112 and 114. Therefore, in the same layer of the second metal layers 112 and 114, redundant metal layers 202, 204 and 206 can be set on the premise that circuit design is not affected. The second area plus the redundant metal layer area is considerably equivalent to the first area. Moreover, the redundant metal layers 202, 204 and 206 and the second metal layer 112, 114 are positioned corresponding to the first metal layer 102 which is subject to a hypothetical central plane which is parallel with the first metal layer 102 and the second metal layer 112, 114. Accordingly, stress of the multi-layer substrate can be balanced to prevent warpage happening.

As shown in FIG. 1, the multi-layer substrate may further comprise a fourth metal layer 102a, a fourth dielectric layer 122a corresponding thereto, fifth metal layers 112a, 114a and fifth dielectric layer 222a corresponding thereto. The fourth metal layer 102a is located at outer side of the first metal layer 102; the fifth metal layers 112a, 114a are located at outer side of the second metal layers 112 and 114. As the fourth metal layer 102a is larger then the fifth metal layers 112a, 114a. Similarly, fifth redundant metal layers 202a, 204a and 206a can be set in the same layer of the fifth metal layers 112a, 114a on the premise that circuit design is not affected. The fifth redundant metal layer area plus the fifth area is considerably equivalent to the fourth area. Moreover, the fifth redundant metal layers 202a, 204a and 206a and the fifth metal layers 112a, 114a are positioned corresponding to the fourth metal layer 102a which is subject to a hypothetical central plane which is parallel with the fourth metal layer 102a and the fifth metal layers 112a, 114a.

With overall consideration for the multi-layer substrate, no matter the two metal layers positioned corresponding to each other are adjacent with each other or not, making the inner of the multi-layer substrate as symmetrical structures described as the first metal layer 102 and the second metal layer 112, 114; as the fourth metal layer 102a and the fifth metal layers 112a, 114a, stresses of the multi-layer substrate can be balanced to decrease warpage thereof. Alternatively, as the fourth metal layer 102a is located at inner side of the first metal layer 102; the fifth metal layers 112a, 114a are located at inner side of the second metal layers 112 and 114, the present invention can still work for balancing stress of the multi-layer substrate, therefore, decreasing warpage of the multi-layer substrate.

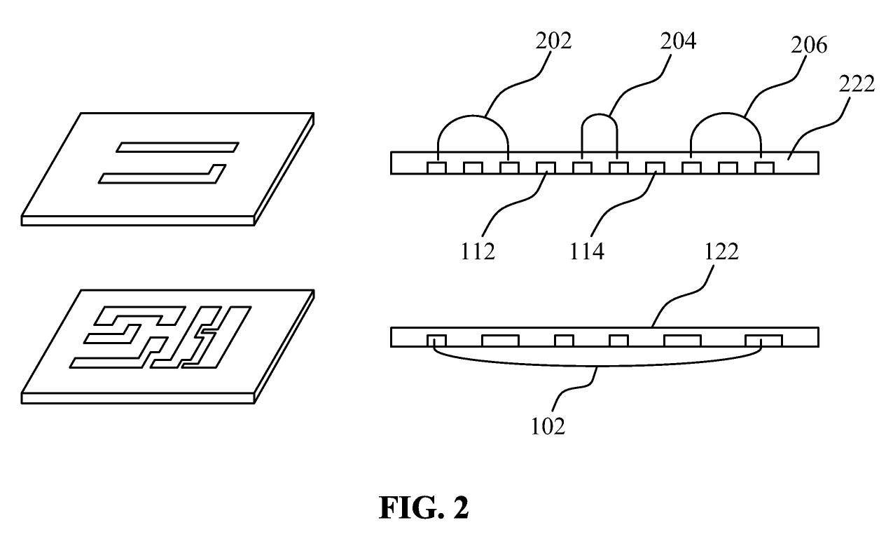

Please refer to FIG. 2, which depicts a diagram of a second embodiment to decrease warpage of a multi-layer substrate according to the present invention. Similarly, on the left side of FIG. 2, a three dimensional view of a multi-layer substrate is shown and a corresponding profile drawing is shown on the right side. The multi-layer substrate comprises a first metal layer 102, a first dielectric layer 122 corresponding thereto, second metal layers 112, 114 and a second dielectric layer 222 corresponding thereto. In this embodiment, pattern of the first metal layer 102 is complex but occupied area thereof is still larger than area of the second metal layers 112, 114. Therefore, in the same layer of the second metal layers 112 and 114, small, distributed redundant metal layers 202, 204 and 206 can be set on the premise that circuit design is not affected. The purpose is that the redundant metal layer area plus the second area remains considerably equivalent to the first area. Moreover, the redundant metal layers 202, 204 and 206 and the second metal layer 112, 114 are positioned corresponding to the first metal layer 102 which is subject to a hypothetical central plane which is parallel with the first metal layer 102 and the second metal layer 112, 114. Accordingly, stress of the multi-layer substrate can be balanced to decrease warpage happening.

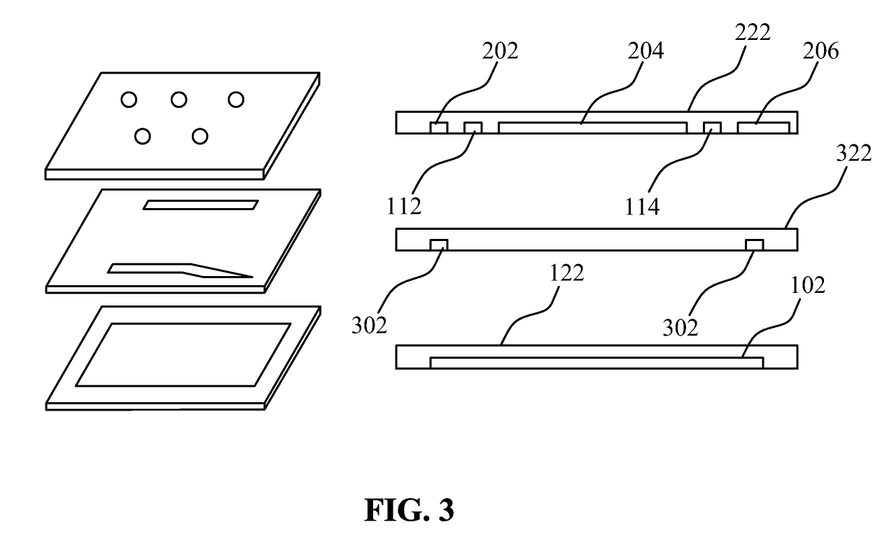

Please refer to FIG. 3, which depicts a diagram of a third embodiment to decrease warpage of a multi-layer substrate according to the present invention. Similarly, on the left side of FIG. 3, a three dimensional view of a multi-layer substrate is shown and a corresponding profile drawing is shown on the right side. The multi-layer substrate comprises a first metal layer 102, a first dielectric layer 122 corresponding thereto, second metal layers 112, 114 and a second dielectric layer 222 corresponding thereto.

Furthermore, the multi-layer substrate can further comprise a third metal layer 302 and a third dielectric layer 322 corresponding thereto between the first metal layer 102 and the second metal layers 112, 114. The occupied area of the third metal layer 302 can be smaller than both areas of the first metal layer 102 and the second metal layers 112, 114. Therefore, consideration of area of the third metal layer 302 therebetween can be ignored but occupied areas locations differences of the first metal layer 102 and the second metal layers 112, 114.

As aforementioned, as making the inner of the multi-layer substrate as symmetrical structures with overall considering the multi-layer substrate, therefore, the present invention can set smaller redundant metal layers 202, 206 and a larger redundant metal layer 204 in the same layer of the second metal layers 112 and 114 on the premise that circuit design is not affected. The purpose is that the redundant metal layer area plus the second area remains considerably equivalent to the first area. Moreover, the redundant metal layers 202, 204 and 206 and the second metal layer 112, 114 are positioned corresponding to the first metal layer 102 which is subject to a hypothetical central plane which is parallel with the first metal layer 102 and the second metal layer 112, 114. Accordingly, stress of the multi-layer substrate can be balanced to prevent warpage happening.

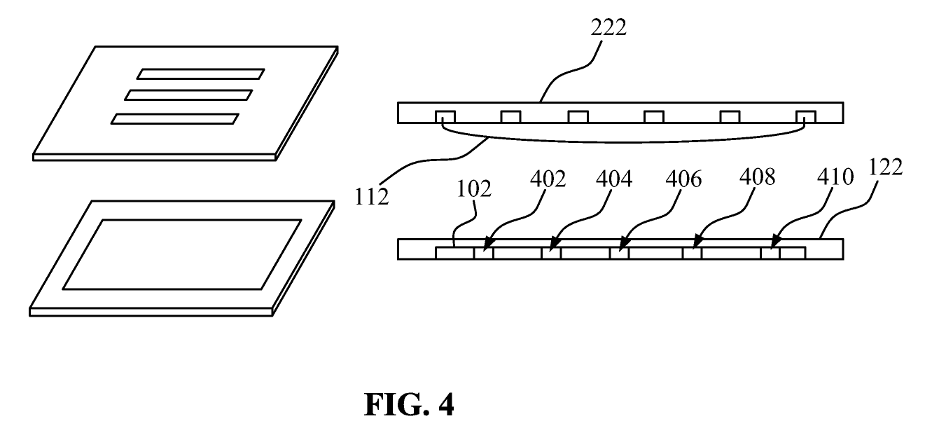

Please refer to FIG. 4, which depicts a diagram of a fourth embodiment to decrease warpage of a multi-layer substrate according to the present invention. Similarly, on the left side of FIG. 4, a three dimensional view of a multi-layer substrate is shown and a corresponding profile drawing is shown on the right side. The multi-layer substrate comprises a first metal layer 102, a first dielectric layer 122 corresponding thereto, second metal layers 112, 114 and a second dielectric layer 222 corresponding thereto.

Occupied area of the first metal layer 102 is larger than area of the second metal layers 112, 114. However, what is different from the aforesaid embodiments is that redundant spaces 402, 404, 406, 408 and 410 can be set in the first metal layer 102 so that first area of the first metal layer 102 subtracting redundant space areas is considerably equivalent to the second area of the second metal layers 112, 114. Besides, the first metal layer 102 subtracting redundant spaces is positioned corresponding to the second metal layer 112 which is subject to a hypothetical central plane which is parallel with the first metal layer 102 and the second metal layer 112. Accordingly, balancing stress of the multi-layer substrate to decrease warpage thereof can be realized. In this embodiment, certainly as similar as described in aforesaid embodiment, the multi-layer substrate may further comprise a fourth metal layer located at inner side or outer side of the of the first metal layer 102; and, the fifth metal layer located at inner side or outer side of the second metal layers 112 and 114. As the fourth metal layer is larger then the fifth metal layers. A fourth redundant space can be set in the fourth metal layer to make the inner of the multi-layer substrate as symmetrical structures. No matter corresponding metal layers are adjacent or not, stress of the multi-layer substrate can be balanced and warpage happening to the multi-layer substrate can be decreased.

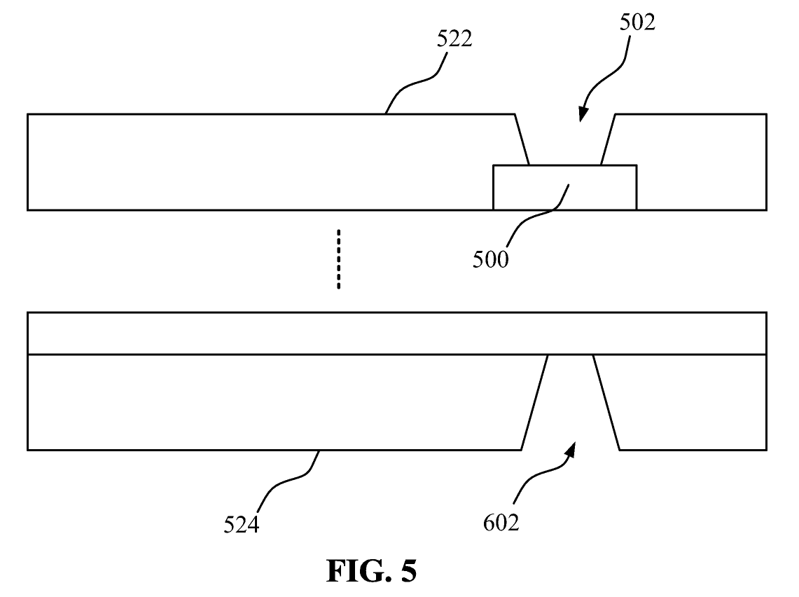

Please refer to FIG. 5, which depicts a diagram of a fifth embodiment to decrease warpage of a multi-layer substrate according to the present invention. As shown in FIG. 5, the multi-layer substrate has an opening 502 in the first surface dielectric layer 522 located at a first surface of the multi-layer substrate at the position of a pad 500. The multi-layer substrate also has a second surface dielectric layer 524 located at a second surface of the multi-layer substrate. With concept of homogenize the multi-layer structure composed of different metal layers and dielectric layers according to the present invention, a redundant opening 602 can be set corresponding to the opening 502 positionally to balance stress of the multi-layer substrate to decrease warpage thereof. Similarly, if the opening 502 is in the inner of the multi-layer substrate, a redundant opening positioned corresponding to the opening 502 still can be set with overall considering the structure of the multi-layer substrate. The stress of the multi-layer substrate still can be balanced and decreasing warpage of the multi-layer substrate still can be realized.

In conclusion, the first to fifth embodiments can be exercised alone or in combination for matching different electric circuit designs when a multi-layer substrate is manufactured. Homogenization for occupied areas and locations of different metal layers and dielectric layers in the multi-layer substrate can be achieved to decrease warpage or twist of the multi-layer substrate.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method to decrease warpage of a multi-layer substrate, the multi-layer substrate comprising a first metal layer and a second metal layer, a first area of the first metal layer is larger than a second area of the second metal layer, wherein at least one redundant metal layer is set in the same layer of the second metal layer so that a redundant metal layer area plus the second area is considerably equivalent to the first area.

2. The method of claim 1, wherein the redundant metal layer and the second metal layer are positioned corresponding to the first metal layer which is subject to a central plane which is parallel with the first metal layer and the second metal layer.

3. The method of claim 1, wherein a third metal layer is located between the first metal layer and the second metal layer.

4. The method of claim 1, wherein the multi-layer substrate further comprises a first surface dielectric layer located at a first surface of the multi-layer substrate that the first surface dielectric layer has at least one opening.

5. The method of claim 4, wherein the multi-layer substrate further comprises a second surface dielectric layer located at a second surface of the multi-layer substrate that the second surface dielectric layer has at least one redundant opening positioned corresponding to the at least one opening.

6. A method to decrease warpage of a multi-layer substrate, the multi-layer substrate comprising a first metal layer and a second metal layer, a first area of the first metal layer is larger than a second area of the second metal layer, wherein at least one redundant space is set in the first metal layer so that the first area subtracting a redundant space area is considerably equivalent to the second area.

7. The method of claim 6, wherein the second metal layer is positioned corresponding to the first metal layer except the redundant space which is subject to a central plane which is parallel with the first metal layer and the second metal layer.

8. The method of claim 6, wherein a third metal layer is located between the first metal layer and the second metal layer.

9. The method of claim 6, wherein the multi-layer substrate further comprises a first surface dielectric layer located at a first surface of the multi-layer substrate that the first surface dielectric layer has at least one opening.

10. The method of claim 9, wherein the multi-layer substrate further comprises a second surface dielectric layer located at a second surface of the multi-layer substrate that the second surface dielectric layer has at least one redundant opening positioned corresponding to the at least one opening.

11. A method to decrease warpage of a multi-layer substrate, comprising a first surface dielectric layer located at a first surface of the multi-layer substrate that the first surface dielectric layer has at least one opening and a second surface dielectric layer located at a second surface of the multi-layer substrate, wherein the second surface dielectric layer has at least one redundant opening positioned corresponding to the at least one opening.

12. A method to decrease warpage of a multi-layer substrate, comprising a first dielectric layer in the multi-layer substrate that the first dielectric layer has at least one opening and a second surface dielectric layer in the multi-layer substrate, wherein the second dielectric layer has at least one redundant opening positioned corresponding to the at least one opening.

13. A multi-layer substrate structure, comprising a first metal layer and a second metal layer, a first area of the first metal layer is larger than a second area of the second metal layer, wherein at least one redundant metal layer is set in the same layer of the second metal layer so that a redundant metal layer area plus the second area is considerably equivalent to the first area.

14. The multi-layer substrate structure of claim 13, wherein the redundant metal layer and the second metal layer are positioned corresponding to the first metal layer which is subject to a central plane which is parallel with the first metal layer and the second metal layer.

15. The multi-layer substrate structure of claim 13, wherein a third metal layer is located between the first metal layer and the second metal layer.

16. The multi-layer substrate structure of claim 13, wherein the multi-layer substrate further comprises a fourth metal layer and a fifth metal layer, located at outer sides of the first metal layer and the second metal layer respectively, a fourth area of the fourth metal layer is larger than a fifth area of the fifth metal layer, wherein at least one fifth redundant metal layer is set in the same layer of the fifth metal layer so that a fifth redundant metal layer area plus the fifth area is considerably equivalent to the fourth area.

17. The multi-layer substrate structure of claim 16, wherein the fifth redundant metal layer and the fifth metal layer are positioned corresponding to the fourth metal layer subject to a central plane parallel with the fourth metal layer and the fifth metal layer.

18. The multi-layer substrate structure of claim 13, wherein the multi-layer substrate further comprises a first surface dielectric layer located at a first surface of the multi-layer substrate that the first surface dielectric layer has at least one opening.

19. The multi-layer substrate structure of claim 18, wherein the multi-layer substrate further comprises a second surface dielectric layer located at a second surface of the multi-layer substrate that the second surface dielectric layer has at least one redundant opening positioned corresponding to the at least one opening.

20. A multi-layer substrate structure, comprising a first metal layer and a second metal layer, a first area of the first metal layer is larger than a second area of the second metal layer, wherein at least one redundant space is set in the first metal layer so that the first area subtracting a redundant space area is considerably equivalent to the second area.

21. The multi-layer substrate structure of claim 20, wherein the second metal layer is positioned corresponding to the first metal layer except the redundant space which is subject to a central plane which is parallel with the first metal layer and the second metal layer.

22. The multi-layer substrate structure of claim 20, wherein a third metal layer is located between the first metal layer and the second metal layer.

23. The multi-layer substrate structure of claim 20, wherein the multi-layer substrate further comprises a fourth metal layer and a fifth metal layer, located at outer sides of the first metal layer and the second metal layer respectively, a fourth area of the fourth metal layer is larger than a fifth area of the fifth metal layer, wherein at least one fourth redundant space is set in the fourth metal layer so that the fourth area subtracting a fourth redundant space area is considerably equivalent to the fifth area.

24. The multi-layer substrate structure of claim 23, wherein the fifth metal layer is positioned corresponding to the fourth metal layer except the fourth redundant space which is subject to a central plane which is parallel with the fourth metal layer and the fifth metal layer.

25. The multi-layer substrate structure of claim 20, wherein the multi-layer substrate further comprises a first surface dielectric layer located at a first surface of the multi-layer substrate that the first surface dielectric layer has at least one opening.

26. The multi-layer substrate structure of claim 25, wherein the multi-layer substrate further comprises a second surface dielectric layer located at a second surface of the multi-layer substrate that the second surface dielectric layer has at least one redundant opening positioned corresponding to the at least one opening.
